(19) United States
(12) Patent Application Publication
(10) Pub. No.: US 2006/0179467 A1
(43) Pub. Date: Aug. 10, 2006

(54) Stock information broadcast device

(76) Inventor: Hsiao-Chieh Chung, Kaohsiung City (TW)

Correspondence Address: BACON & THOMAS, PLLC, 625 SLATERS LANE, FOURTH FLOOR, ALEXANDRIA, VA, 22314, US

(21) Appl. No.: 11/141,332

(22) Filed: Jun. 1, 2005

(30) Foreign Application Priority Data
Feb. 4, 2005 (TW) 093102447

(51) Int. Cl. H04N 7/173

(52) U.S. Cl. 725/109; 725/110; 725/112

(57) ABSTRACT

The present invention provides a stock information broadcast device for broadcasting dynamically updated stock information. The device has a processor for controlling a radio receiving module, a screen and an audio output device, wherein the processor is able to execute a program for achieving the following functions: operating a first selection operation for selecting at least one stock information as a selected stock information; operating a display operation for displaying the selected stock information on the screen; operating a second selection operation for selecting at least one trading information to be outputted to the audio output device, and operating a broadcast operation for broadcasting the selected trading information.

### BACKGROUND OF THE INVENTION

1) Field of the Invention

This invention relates to a stock information broadcast device, in particular, a portable device that is used to broadcast audio stock information.

2) Description of the Prior Art

Generally, there are several ways for users to use electronic devices to obtain stock information as follows.

A user may choose to listen to stock information on the radio. The advantage lies in that the user is able to listen to stock information on the radio at the same time while s/he is mind her/his own business; nevertheless, the disadvantage lies in that numerous stocks make the user unable to quickly pick his/her preferred stocks, therefore, the user has to pay attention to listen to the information on the radio from beginning to finish, so as to waste time.

In addition, a user may choose to browse stock market information on certain websites. Said websites enable the user to choose his/her preferred stocks and watch selected stock information on the screen; nevertheless, the user has to constantly monitor stock information on the screen and hardly has time to do other things at the same time (e.g., work requires attention of eyes).

A portable information display device (i.e., a stock ticker) can be applied to display stock market information. Generally, said stock ticker enables a user to watch and select stocks via the displcy, but lacks the function of wireless transmission; in addition, said portable device enables a user to receive the latest stock market information on the go. However, said device has the disadvantage that a user has to constantly watch updated stock information, it would be inconvenient for a user to frequently monitor the stock information news when s/he is concentrating on other business, such as driving a car.

Therefore, the disadvantage for a user to obtain stock market information from a conventional stock information device is necessary to be improved.

### SUMMARY OF THE INVENTION

In view of the foregoing drawbacks, the main objective of the invention is to provide a stock information broadcast device that concurrently consists of the screen displaying and audio broadcasting functions for a user to dynamically receive the latest stock market information by watching the display and/or listening to the audio broadcasting anytime for convenience' sake.

Another objective of of the invention is to provide a stock information broadcast device that consists of the function of multiple audio broadcasting, so that a user is able to operate stock information broadcasting from multiple-choice methods.

To achieve the above objectives, the invention provides a stock information broadcast device, enabling updated stock information to be dynamically broadcasted. Said stock information broadcast device of the invention comprises a radio receiving module, a memory, a sound chip , a screen, an audio output device, a processor and a plurality of buttons. The radio receiving module can be used to dynamically receive a plurality of updated stock information, wherein the stock information each comprises a plurality of trading information, each of which corresponds to a stock name. The processor is used to control the radio receiving module, the screen and the audio output device, in addition, execute a program in memory or a sound chip to achieve the functions of displaying stock market information on the screen and outputting stock information to the audio output device for broadcasting.

One preferred embodiment of the invention shows that the display operation is executed according to the following steps of operating a first selection operation, selecting at least one stock information item as selected stock information; and executing a display operation to display selected stock information on the screen.

One preferred embodiment of the invention shows that the audio broadcast operation is carried out according to the following steps of operating a second selection operation for selecting at least one trading information item from selected stock information to be outputted to the audio output device, and operating a broadcast operation for broadcasting the selected trading information, and making a corresponding stock name as audio information to be outputted to the audio output device for broadcasting.

### BRIEF DESCRIPTION OF THE DRAWINGS

FIG. 1 is a circuit diagram of a portable stock information broadcast device according to the invention;

FIG. 2 is a diagram showing a main program for operating stock information according to the invention;

FIG. 3 is a front view of the stock information broadcast device showing the state diagram of a plurality of stock information on the screen according to the invention;

FIG. 4 is a diagram showing a first selection operation on the stock information broadcast device according to the invention;

FIG. 5 is a diagram showing a display operation on the stock information broadcast device according to the invention;

FIG. 6 is a diagram showing a second selection operation on the stock information broadcast device according to the preferred embodiment of the invention; and

FIG. 7 is a diagram showing a broadcast operation of updated trading information on the stock information broadcast device according to the invention.

### DETAILED DESCRIPTION OF THE PREFERRED EMBODIMENTS

To enable a further understanding of the structural features and the technical contents of the invention, the brief description of the drawings below is followed by the detailed description of embodiments.

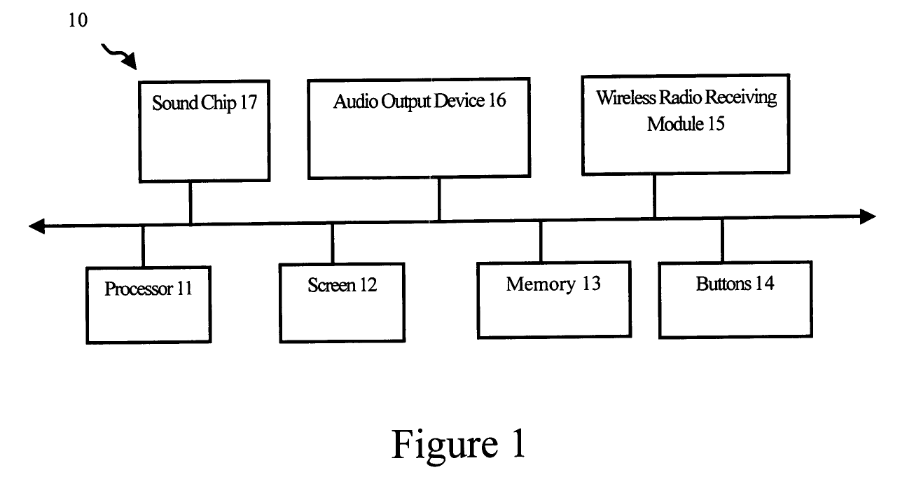

FIG. 1 is a circuit diagram of a portable stock information broadcast device according to the invention. The invention provides a stock information broadcast device 10, comprising a processor 11, a screen 12 electrically connected the processor 11, a memory 13, a plurality of buttons 14, a radio receiving module 15, an audio output device 16 and a sound chip 17. Seeing that hardware components of the invention adopts the same structure of conventionally known components and are similar to general computer structure, no further discussion on respective components is given herein.

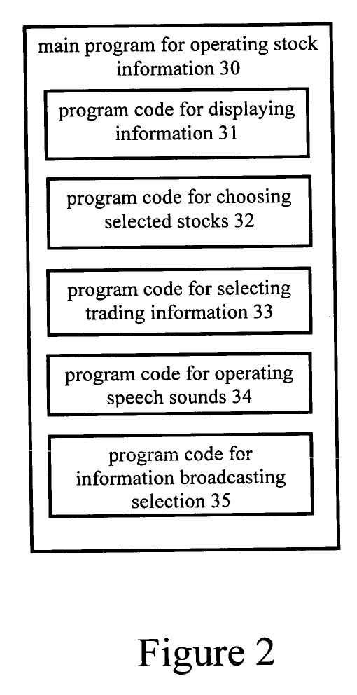

FIG. 2 is a diagram showing a main program for operating stock information 30 according to the invention. The main program of operating stock information is to transmit received stock information to a user on the screen or by broadcasting. Seeing that the transmission of stock information on the screen to a user is a conventional technology, no description thereof, but the characteristics in relation to the invention will be made further. The characteristics of the main program 30 in relation to the invention comprise a program code for displaying information 31, a program code for choosing a selected stock 32, a program code for selecting trading information 33, a program code for operating speech sounds 34 and a program code for information broadcasting selection 35. The respective descriptions of said program codes are made as follows.

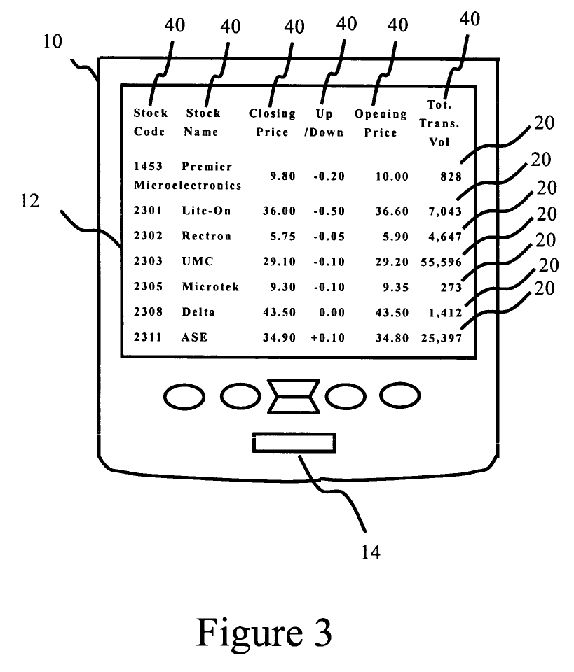

FIG. 3 illustrates an embodiment of the invention, showing a front view of the stock information broadcast device 10, i.e., the state diagram of displaying a plurality of stock information 20 on the screen 12. The optimum of the invention is the portable design of the device, which enables a user to carry with him/her for use. As shown in FIG. 2, a plurality of stock information 20 is received through the radio receiving module 15 and stored at the main program 30 for operating stock information in the memory 13 by way of the processor 11, and subsequently, displayed on the screen 12.

As shown in FIG. 3 that each stock information item 20 displayed on the screen 12 comprises a plurality of trading information 40, such as “stock code”, “stock name”, “closing price”, “up/down”, “opening price” and “total trans. volume”, etc. Taking “Premier Microelectronics” as an example that the stock information 20 consists of a plurality of trading information 40 of the company, including a “stock code” as 1453, a “stock name” as Premier Microelectronics, “closing price” at 9.80, “up/down” at −0.20, “opening price” at 10.00 with 828 of “total trans. volume” etc.

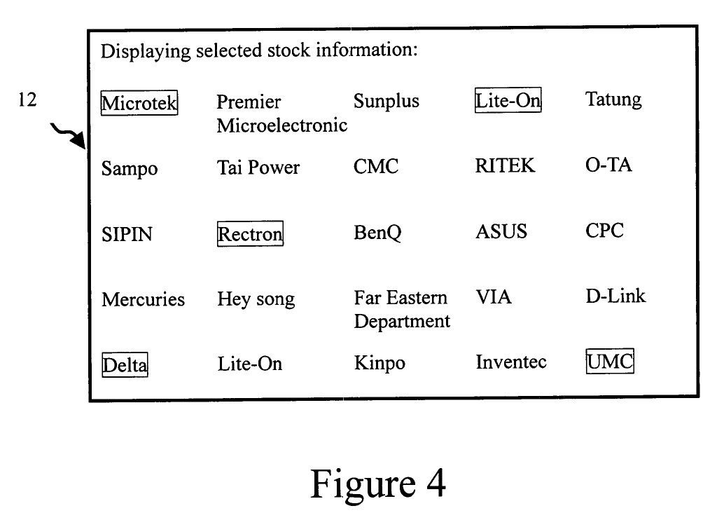

FIG. 4 is an embodiment of the invention showing a first selection operation in the stock information broadcast device 10. As shown in FIG. 4 that a user presses buttons 14 to trigger the processor 11 to execute the program code for choosing a selected stock 32 that is stored in the memory 13 and execute a first selection operation by displaying a stock name as selected stock name on the screen 12. As shown in FIG. 4, there are five stock names, Lite-On, Rectron, UMC, Microtek and Delta Electronic, are selected. A preferred embodiment of the invention is to press the buttons 14 to process the first selection operation. It should be noted that the screen 12 is designed as a touch screen for a user to execute the operation of selecting stock information by either a touch pen or a finger. Seeing that said function is the same as provided in a conventional stock ticker, no further description thereof is made below.

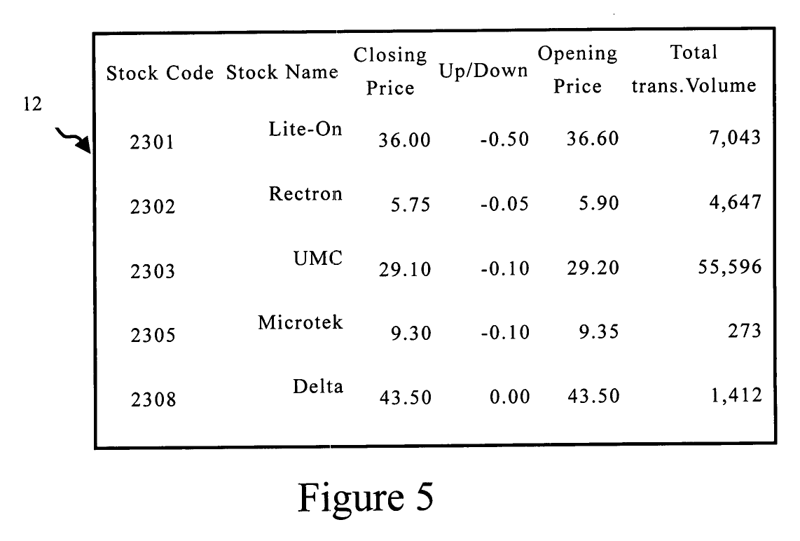

FIG. 5 is a diagram showing a display operation on the stock information broadcast device 10 according to the preferred embodiment of the invention. With reference to FIG. 5, the five selected stock information items in relation to Lite-On, Rectron, UMC, Microtek and Delta Electronic in FIG. 4 are displayed on the screen 12, said operation of displaying stock information on the screen is executed by the program code for displaying information 31. As shown in FIG. 5, a plurality of stock information items that are displayed on the screen 12 are listed in sort order of ascending respective stock codes; nevertheless, the user may choose another way to display the tock information items, such as in order of respective closing prices or total trans. volumes. The display of a plurality of stock information on the screen 12 and related methods are conventional technologies that are not described further hereafter.

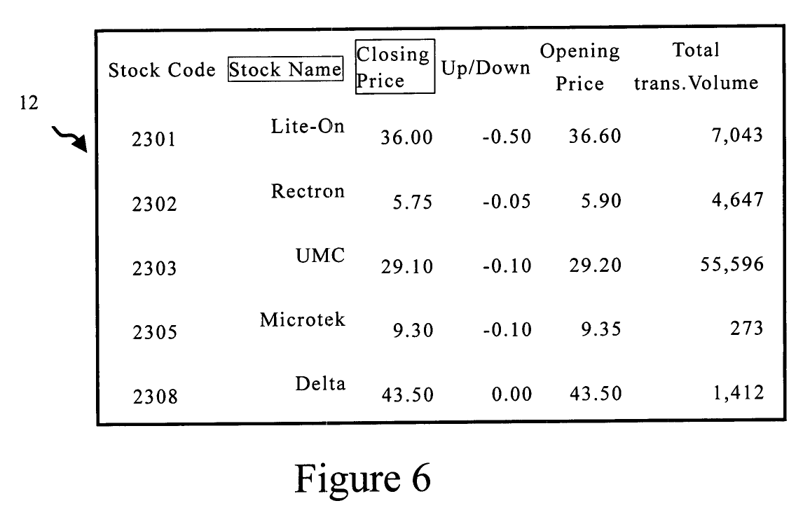

FIG. 6 is a diagram showing a second selection operation on the stock information broadcast device 10 according to the preferred embodiment of the invention. With reference to FIG. 6, a user presses the buttons 14 to trigger the processor 11 to execute the program code for selecting trading information 33 that is stored in the memory 13 and execute a second selection operation for the user to select stock information to be outputted to the audio output device 16 for broadcasting. The invention enables the user to select at least one and above trading information items 40 for broadcasting. As shown in FIG. 6, the stock name and the closing price are both selected as the items for broadcasting in the preferred embodiment, therefore, the information that is outputted to the audio output device 16 comprises “stock name” and “closing price” of selected stocks. Generally, people consider that visual information reading is quicker than data receiving by listening; therefore, the second selection operation of the invention enables a user to select the information that s/he is willing to receive and sieve out unwanted information. Such a function can be regarded as one of the characteristics of the invention. In addition, a preferred embodiment of the invention is to press the buttons 14 to process the second selection operation. It should be noted that the screen 12 could be designed as a touch screen for a user to execute the operation of selecting stock information by either a touch pen or a finger.

After the completion of the operation of broadcasting selected stock information, the processor 11 then executes the program code for operating speech sounds 34 to broadcast the trading information items 40 that are selected from the second selection operation, namely, output the trading information items 40 to the audio output device 16 by speech sounds. In the preferred embodiment, the invention transmits character information to the sound chip 17 for transforming those character items into phonetic information. It should be noted that the memory 13 is able to equip with softeare program that produces a “sound” or voice output transformation; therefore, the sound chip 17 is not a necessary component.

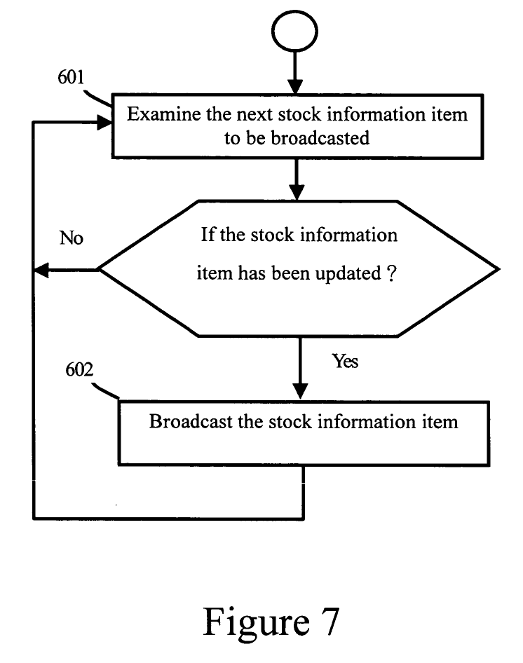

Moreover, the preferred embodiment of the invention illustrates that the broadcast operation enables selected trading information to be broadcasted in various sort orders, in addition, enables the trading information that is only updated to be broadcasted to the user. FIG. 7 is a flow chart showing the broadcast of updated trading information in the preferred embodiment of the invention, said operation is executed by the program code for information broadcasting selection 35. As shown in FIG. 7, after broadcasting each trading information item, the invention then immediately proceeds step 601 to examine the next trading information that is going to be broadcasted, to see if the trading information item is updated. If the next trading information that is going to be broadcasted had been updated after the previous broadcasting, the invention then proceeds step 602 to broadcast the trading information item; or the invention goes back to step 601 to examine the following trading information that is going to be broadcasted. Therefore, the invention only broadcasts the trading information items that are updated. In addition, the preferred embodiment of the invention illustrates the function that enables a user to adjust the sound volume and speed of trading information broadcasting (not shown).

It should be noted that the aforementioned technology could be operated on a personal computer plateform (not shown) by putting the program code for selecting trading information 33, the program code for operating speech sounds 34 and the program code for information broadcasting selection 35 into the main program of operating stock information on a conventional PC structure. The invention also enables a personal computer to obtain stock information by the radio receiving module or wire transmisstion, such as obtaining stock information from Internet. Besides, a PC has a powerful processor to proceed programs, therefore, the sound chip is not necessary to be equipped therewith. Moreover, a PC keyboard or a mouse can replace the plurality of buttons 14 in the preferred embodiment of the invention.

It is known from the said embodiment that the invention illustrated with the characteristics is different from conventional technology from the perspectives of objectives, means and effects. In conclusion from the above, the disclosed structure of the invention is new design separating from prior arts. The present invention is, therefore, disclosed herein for its practicability and advancement. It is of course to be understood, however, that this disclosure is, in many respects, only illustrative in the above preferred embodiments. The scope of the invention is, of course, defined in the language in which the appended claims are expressed. For example, the first selection operation and the second selection operation are not necessary to be equipped together thereof; nevertheless, if only the first selection operation exists, a user is unable to select whick trading information item would be broadcasted; if only the second selection operation exists, a user is unable to select stock information s/he wants.

What is claimed is:

1. A stock information broadcast device for dynamically broadcasting updated stock information, comprising:
a screen;
a processor;
an audio output device;
a radio receiving module for dynamically receiving a plurality of updated stock information, wherein the stock information each comprises a plurality of trading information;
a plurality of buttons;
a memory electrically connecting the processor and comprising a program;
thereby the radio receiving module, the screen and the audio output device can be controlled by the processor, executing the program in the memory for achieving the following functions and mechanisms:
executing a first selection operation for selecting at least one stock information I tem as selected stock information from the plurality of stock information received by the radio receiving module;
operating a display operation for displaying the selected stock information on the screen; and
operating a broadcast operation for selecting at least one trading information item to be outputted to the audio output device, and operating a broadcast operation for broadcasting the selected trading information.

2. The stock information broadcast device of claim 1 further comprises the step of executing a second selection operation for selecting at least one trading information item from the selected stock information to be outputted to the audio output device, enabling the operation of a broadcast operation for broadcasting at least one trading information item selected from the second selection operation as phonetic information to be outputted to the audio output device for broadcasting.

3. The stock information broadcast device of claim 1 further comprises a sound chip for transforming character information into phonetic information.

4. The stock information broadcast device of claim 1, wherein the function of operating a broadcast operation merely broadcasts the trading information of selected stock information that is updated.

5. The stock information broadcast device of claim 1, wherein the stock information broadcast device is a portable device.

6. The stock information broadcast device of claim 1, wherein the trading information is a group of information comprising a stock code, a stock name, a closing price, a opening price, a price up/down and a total trans. volume.

7. The stock information broadcast device of claim 1, wherein the radio receiving module is a wireless radio receiving module.

8. A stock information broadcast device for dynamically broadcasting updated stock information, comprising:
a screen;
a processor;
an audio output device;
a radio receiving module for dynamically receiving a plurality of updated stock information, wherein the stock information each comprises a plurality of trading information;
a plurality of buttons;
a memory electrically connecting the processor and comprising a program;
thereby the processor could control the radio receiving module, the screen and the audio output device and execute the program in the memory for achieving the following functions and mechanisms:
executing a second selection operation for selecting at least one trading information item from the stock information to the audio output device; and
operating a broadcast operation for selecting at least one trading information item from the second selection operation to be transformed into phonetic information and outputted to the audio output device for broadcasting.

9. A computer readable article for enabling a user to dynamically listen to a plurality of updated stock information, wherein the stock information comprises a plurality of trading information, the article comprising the following recordable program code, a program code for displaying information for displaying the plurality of stock information on a screen;
a program code for choosing a selected stock for proceeding a first selection operation, selecting at least one stock information item from the plurality of stock information as selected stock information; and
a program code for operating speech sounds for broadcasting stock information, selecting at least one trading information item from the selected stock information for being transformed into phonetic information and outputted to the audio output device for broadcasting.

10. The article of claim 9, further comprising a program code for selecting trading information, enabling the second selection operation to be executed for selecting at least one trading information item from the selected stock information to be transformed into phonetic information and outputted to the audio output device for broadcasting.

11. The article of claim 9, further comprising a program code for information broadcasting selection for broadcasting updated trading information from the selected stock information.

12. A computer readable article for enabling a user to dynamically listen to a plurality of updated stock information, wherein the stock information comprises a plurality of trading information, the article comprising the following recordable program code,
a program code for displaying information for displaying the plurality of stock information on a screen;
a program code for choosing a trading information for proceeding a second selection operation, selecting at least one trading information item from the stock information to be outputted to an audio output device;
a program code for operating speech sounds for broadcasting stock information, transforming and outputting at least one trading information item selected by the second selection operation to the audio output device for broadcasting.
